(19) United States
(12) Patent Application Publication
(10) Pub. No.: US 2026/0172099 A1
(43) Pub. Date: Jun. 18, 2026

(54) MECHANISM FOR BEAM PREDICTION

(71) Applicant: Nokia Technologies OY, Espoo (FI)

(72) Inventors: Tachporn SANGUANPUAK, Espoo (FI); Keeth Saliya Jayasinghe LADDU, Espoo (FI); Juha Pekka KARJALAINEN, Espoo (FI); Timo KOSKELA, Espoo (FI)

(73) Assignee: Nokia Technologies OY, Espoo (FI)

(21) Appl. No.: 19/416,172

(22) Filed: Dec. 11, 2025

Related U.S. Application Data
(60) Provisional application No. 63/733,532, filed on Dec. 13, 2024.

(51) Int. Cl. H04B 7/06; H04W 24/02

(52) U.S. Cl. CPC H04B 7/0696; H04W 24/02

(57) ABSTRACT

Example embodiments of the present disclosure are directed to beam prediction. An apparatus determines an input of an artificial intelligence/machine learning, AI/ML model for uplink beam pair prediction. The apparatus determines an output of the AI/ML model for uplink beam pair prediction by applying the input to the AI/ML model for uplink beam pair prediction. The apparatus determines, based on the output of the AI/ML model for uplink beam pair prediction, one or more predicted uplink beam pairs. Each predicted uplink beam pair includes a first beam for a first transmission reception point, TRP, and a second beam for a second TRP.

### FIELD

Various example embodiments of the present disclosure generally relate to the field of telecommunication and in particular, to methods, devices, apparatuses and computer readable storage medium for beam prediction.

### BACKGROUND

Due to the great success of artificial intelligence (AI)/machine learning (ML) technologies, the AI/ML study item, which may refer to user equipment (UE)-sided model and network (NW) sided model, has been discussed in 3^{rd} generation partnership project (3GPP). For example, AI/ML based beam prediction may be performed.

### SUMMARY

In a first aspect of the present disclosure, there is provided a first apparatus. The first apparatus comprises at least one processor; and at least one memory storing instructions that, when executed by the at least one processor, cause the first apparatus to: receive, from a second apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP, and the configuration further comprises at least one associated identity which comprises at least one of: an antenna configuration of the first TRP, an antenna configuration of the second TRP, or a pathloss reference for uplink transmission; perform a first measurement of the first set of beams and a second measurement of the second set of beams; determine, based on measurement results of the first and second measurements, one or more predicted uplink beam pairs using an artificial intelligence/machine learning, AI/ML model, each predicted uplink beam pair comprising a first beam from the third set of beams and a second beam from the fourth set of beams; and transmit, to the second apparatus, a report associated with the one or more predicted uplink beam pairs.

In a second aspect of the present disclosure, there is provided a second apparatus. The second apparatus comprises at least one processor; and at least one memory storing instructions that, when executed by the at least one processor, cause the second apparatus to: transmit, to a first apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP, and the configuration further comprises at least one associated identity which comprises at least one of: an antenna configuration of the first TRP, an antenna configuration of the second TRP, or a pathloss reference for uplink transmission; and receive, from the first apparatus, a report associated with one or more predicted uplink beam pairs, wherein the one or more predicted uplink beam pairs are determined using an artificial intelligence/machine learning, AI/ML model, each predicted uplink beam pair comprising a first beam from the third set of beams and a second beam from the fourth set of beams.

In a third aspect of the present disclosure, there is provided an apparatus. The apparatus comprises at least one processor; and at least one memory storing instructions that, when executed by the at least one processor, cause the apparatus to: determine an input of an artificial intelligence/machine learning, AI/ML model for uplink beam pair prediction; determine an output of the AI/ML model for uplink beam pair prediction by applying the input to the AI/ML model for uplink beam pair prediction; and determine, based on the output of the AI/ML model for uplink beam pair prediction, one or more predicted uplink beam pairs, each predicted uplink beam pair comprising a first beam for a first transmission reception point, TRP, and a second beam for a second TRP.

In a fourth aspect of the present disclosure, there is provided a method. The method comprises: receiving, at a first apparatus and from a second apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP, and the configuration further comprises at least one associated identity which comprises at least one of: an antenna configuration of the first TRP, an antenna configuration of the second TRP, or a pathloss reference for uplink transmission; performing a first measurement of the first set of beams and a second measurement of the second set of beams; determining, based on measurement results of the first and second measurements, one or more predicted uplink beam pairs using an artificial intelligence/machine learning, AI/ML model, each predicted uplink beam pair comprising a first beam from the third set of beams and a second beam from the fourth set of beams; and transmitting, to the second apparatus, a report associated with the one or more predicted uplink beam pairs.

In a fifth aspect of the present disclosure, there is provided a method. The method comprises: transmitting, at a second apparatus and to a first apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP, and the configuration further comprises at least one associated identity which comprises at least one of: an antenna configuration of the first TRP, an antenna configuration of the second TRP, or a pathloss reference for uplink transmission; and receiving, from the first apparatus, a report associated with one or more predicted uplink beam pairs, wherein the one or more predicted uplink beam pairs are determined using an artificial intelligence/machine learning, AI/ML model, each predicted uplink beam pair comprises a first beam from the third set of beams and a second beam from the fourth set of beams.

In a sixth aspect of the present disclosure, there is provided a method. The method comprises: determining an input of an artificial intelligence/machine learning, AI/ML model for uplink beam pair prediction; determining an output of the AI/ML model for uplink beam pair prediction by applying the input to the AI/ML model for uplink beam pair prediction; and determining, based on the output of the AI/ML model for uplink beam pair prediction, one or more predicted uplink beam pairs, each predicted uplink beam pair comprising a first beam for a first transmission reception point, TRP, and a second beam for a second TRP.

In a seventh aspect of the present disclosure, there is provided a first apparatus. The first apparatus comprises means for receiving, from a second apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP; means for performing a first measurement of the first set of beams and a second measurement of the second set of beams, and the configuration further comprises at least one associated identity which comprises at least one of: an antenna configuration of the first TRP, an antenna configuration of the second TRP, or a pathloss reference for uplink transmission; means for determining, based on measurement results of the first and second measurements, one or more predicted uplink beam pairs using an artificial intelligence/machine learning, AI/ML model, each predicted uplink beam pair comprising a first beam from the third set of beams and a second beam from the fourth set of beams; and means for transmitting, to the second apparatus, a report associated with the one or more predicted uplink beam pairs.

In an eighth aspect of the present disclosure, there is provided a second apparatus. The second apparatus comprises means for transmitting, to a first apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP, and the configuration further comprises at least one associated identity which comprises at least one of: an antenna configuration of the first TRP, an antenna configuration of the second TRP, or a pathloss reference for uplink transmission; and means for receiving, from the first apparatus, a report associated with one or more predicted uplink beam pairs, wherein the one or more predicted uplink beam pairs are determined using an artificial intelligence/machine learning, AI/ML model, each predicted uplink beam pair comprising a first beam from the third set of beams and a second beam from the fourth set of beams.

In a ninth aspect of the present disclosure, there is provided an apparatus. The apparatus comprises means for determining an input of an artificial intelligence/machine learning, AI/ML model for uplink beam pair prediction; means for determining an output of the AI/ML model for uplink beam pair prediction by applying the input to the AI/ML model for uplink beam pair prediction; and means for determining, based on the output of the AI/ML model for uplink beam pair prediction, one or more predicted uplink beam pairs, each predicted uplink beam pair comprising a first beam for a first transmission reception point, TRP, and a second beam for a second TRP.

In a tenth aspect of the present disclosure, there is provided a computer readable medium. The computer readable medium comprises instructions stored thereon for causing an apparatus to perform at least the method according to any of the fourth, fifth, or sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of multi-transmission reception point (TRP) operation;

FIG. 3 illustrates a signaling chart for beam prediction according to some example embodiments of the present disclosure;

FIG. 4 illustrates a schematic diagram of different combinations of two panels for simultaneous transmission and simultaneous reception;

FIG. 5 illustrates a schematic diagram of AI/ML model for spatial domain beam pair prediction according to some example embodiments of the present disclosure;

FIG. 6 illustrates a signaling chart for beam prediction according to some example embodiments of the present disclosure;

FIG. 7 illustrates a flowchart of a method implemented at a first apparatus in accordance with some example embodiments of the present disclosure;

FIG. 8 illustrates a flowchart of a method implemented at a second apparatus in accordance with some example embodiments of the present disclosure;

FIG. 9 illustrates a flowchart of a method implemented at an apparatus in accordance with some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
   (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. As used herein, the term “transmission reception point (TRP)” may refer to a device/entity where radio signals are transmitted and received. It refers to a component of a wireless network that is capable of both transmitting and receiving signals, which can be a part of a base station or access point. In the context of 5G and advanced wireless systems, a TRP may involve multiple antenna elements arranged in an array to facilitate the transmission and reception of radio waves for communication purposes. TRPs play a crucial role in ensuring coverage, capacity, and the overall performance of wireless networks.

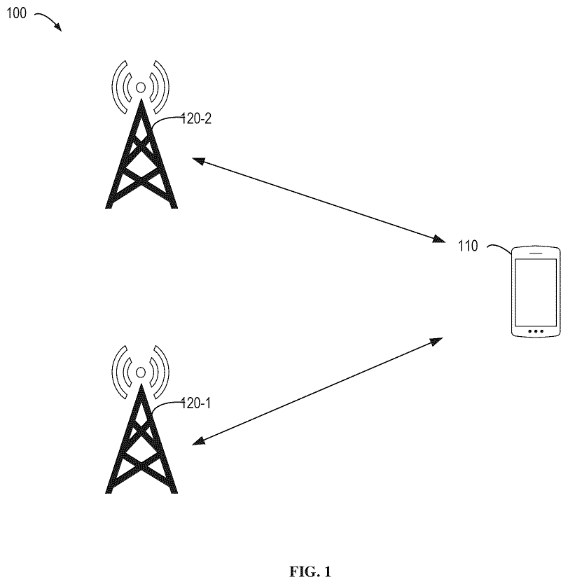

FIG. 1 illustrates an example communication environment 100 in which example embodiments of the present disclosure can be implemented. In the communication environment 100, a plurality of communication devices, including a terminal device 110 and a network device 120 (for example, the network devices 120-1 and 120-2 which are collectively referred to as “network device 120”), can communicate with each other. In the example of FIG. 1, the terminal device 110 may be a UE and the network devices 120-1 and 120-2 may be base stations.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in a serving cell of the terminal device 110, and one or more additional cells may be deployed in the communication environment 100. It is noted that although illustrated as a network device, the network device 120 may be another device than a network device. Although illustrated as a terminal device, the terminal device 110 may be another device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, a transmission direction from the network device 120 to the terminal device 110 is referred to as a downlink (DL), while a transmission direction from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

Communications in the communication environment 100 may be implemented according to any proper communication protocol(s), comprising, but not limited to, cellular communication protocols, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As mentioned above, AI/ML based beam prediction is introduced. For example, AI/ML may be used for beam management. The AI/ML-based beam management may include leveraging AI/ML models to predict the best beam(s) based on a limited set of measurements. There may be two sub-use cases for beam prediction including spatial-domain prediction and time-domain prediction. In the sub-use case spatial domain prediction, beam prediction may be based on a limited set of measurements that does not contain any historical information. In the sub-use case time-domain prediction, beam prediction into the future may be based on a limited set of measurements that contains historical information.

In addition, measurements and prediction may be based on two beam sets: Set A where the complete set of beams over which the prediction will operate and Set B where the set of beams whose measurements are inputted to the AI/ML model (e.g., layer 1-reference signal received power (L1-RSRP) and the like). Set B can be different from Set A (space-domain and time-domain prediction) or a subset of Set A (space-domain and time-domain prediction) or same as Set A (time-domain prediction).

The release-19 (Rel-19) work item (WI) on AI/ML for NR Air Interface, based on the AI/ML techniques to NR air interface, has been approved. For example, it supports the following aspects: (1) AI/ML general framework for one-sided AI/ML models: signalling and protocol aspects of Life Cycle Management (LCM) enabling functionality and model (if justified) selection, activation, deactivation, switching, fallback; necessary signalling/mechanism(s) for LCM to facilitate model training, inference, performance monitoring, data collection for both UE-sided and NW-sided models; signalling mechanism of applicable functionalities/models; and (2) beam management-DL transmitting (Tx) beam prediction for both UE-sided model and NW-sided model, encompassing: spatial-domain DL Tx beam prediction for Set A of beams based on measurement results of Set B of beams (“BM-Case1”); temporal DL Tx beam prediction for Set A of beams based on the historic measurement results of Set B of beams (“BM-Case2”); specify necessary signalling/mechanism(s) to facilitate LCM operations specific to the Beam Management use cases, if any; enabling method(s) to ensure consistency between training and inference regarding NW-side additional conditions (if identified) for inference at UE. Further, study objectives with corresponding checkpoints may include necessity and details of model Identification concept and procedure in the context of LCM; core network (CN)/operation, administration, and maintenance (OAM)/over the top (OTT) collection of UE-sided model training data: for the FS_NR_AIML_Air study use cases, identify the corresponding contents of UE data collection; and analyse the UE data collection mechanisms identified during the FS_NR_AIML_Air study along with the implications and limitations of each of the methods; and model transfer/delivery where whether there is a need to consider standardised solutions for transferring/delivering AI/ML model(s) considering at least the solutions identified is determined during the FS_NR_AIML_Air study.

Moreover, group-based beam reporting is proposed. Group-based beam reporting has been supported since NR Rel-15 and further optimized in Rel-17 to support multi-TRP operations. The features of group-based beam reporting are summarized below:
Rel-15 group-based beam reporting (groupBasedBeamReporting) allows UE to report two beams that can be received simultaneously by the UE. The UE is unaware that two beams are from the same TRP or different TRPs.
Rel-15 reporting is valid for L1-RSRP or L1-signal to interference plus noise ratio (SINR) reporting (a CSI-ReportConfig with reportQuantity set to ‘CSI-RS resource indicator (cri)-RSRP’, ‘synchronization signal block (ssb)-Index-RSRP’, ‘cri-RSRP-Capability[Set]Index’, ‘ssb-Index-RSRP-Capability[Set]Index’, ‘cri-SINR’, ‘ssb-Index-SINR’, ‘cri-SINR-Capability[Set]Index’ or ‘ssb-Index-SINR-Capability[Set]Index’).
Rel-17 group-based beam reporting allows UE to report group(s) of two CSI-RS resource indicators (CRI)or synchronization signal (SS)/physical broadcast channel (PBCH) block resource indicator (SSBRIs) selecting one channel state information-reference signal (CSI-RS) or synchronization signal (SS)/physical broadcast channel (PBCH) block (SSB) from each of the two CSI Resource Sets for the report setting, where CSI-RS and/or SSB resources of each group can be received simultaneously by the UE. Here, the UE is aware of the beam to TRP association, and reported beams in a beam group are from different TRPs.
Rel-17 group-based beam reporting (groupBasedBeamReporting-r17) is supported by configuring the UE two CSI Resource Sets. Otherwise, the number of CSI-RS Resource Sets configured is limited to one.
Rel-17 reporting is valid for L1-RSRP reporting (a CSI-ReportConfig with reportQuantity set to ‘cri-RSRP’, ‘ssb-Index-RSRP’, ‘cri-RSRP-Capability[Set]Index’, or ‘ssb-Index-RSRP-Capability[Set]Index’).

In some cases, the UE is configured with a CSI-ReportConfig with the higher layer parameter reportQuantity set to ‘cri-RSRP’, ‘ssb-Index-RSRP’, ‘cri-RSRP-Index’ or ‘ssb-Index-RSRP-Index’. Specifically, if the UE is configured with the higher layer parameter roupBasedBeamReporting-v18 set to ULOnly, the UE is not required to update measurements for more than 64 CSI-RS and/or SSB resources, and the UE shall report in a single reporting instance nrofReportedGroups-r18, if configured, group(s) of two CRIs or SSBRIs selecting one CSI-RS or SSB from each of the two CSI Resource Sets for the report setting, where CSI-RS and/or SSB resources of each group can be applied for simultaneous transmission with spatial filters by the UE subject to UE capability. In summary, for UL only mode: each group consist of two CRIs or SSBRIs where one CSI-RS or SSB selected from each of the two CSI Resource Sets; CSI-RS and/or SSB resources of each group can be applied for simultaneous transmission with spatial filters.

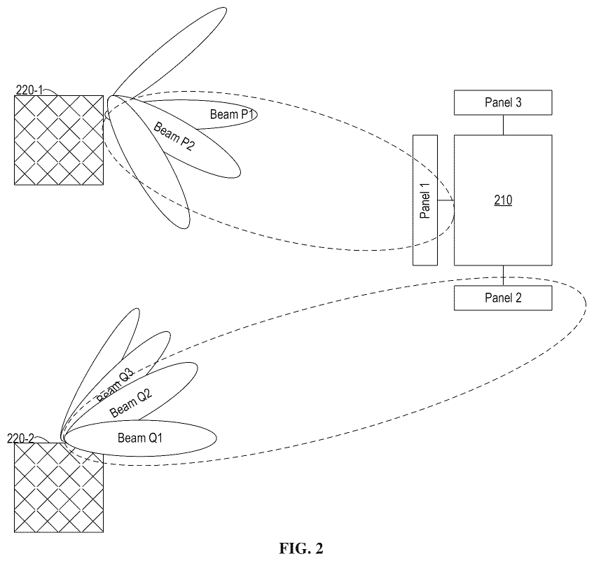

In frequency range (FR)2 or FR3 (high frequency portion, such as, 10 GHz to 20 GHz), to support multi-TRP (m-TRP) operations, the UE may use multiple panels, as beams may be received from different panels such that simultaneous reception is facilitated. As illustrated in FIG. 2, not all beams may be suitable for joint transmission towards the UE 210. The UE 210 may be configured with panels 1, 2 and 3. The UE 210 may receive signals from beams P1 and P2 of the TRP 220-1 using panel 1 and receives signals from beams Q1 and Q2 of the TRP 220-2. The UE 210 may be not able to simultaneously receive signals from beams Q3 and P1 (or #P2) as they are received at the same panel (i.e., pane 1). In other words, there are not many occasions in FR2 or FR3 (high frequency) where a UE would be able to receive simultaneously signals from two TRPs unless the UE has different panels, and hence the benefit for the network of scheduling transmission on both beams is questionable. This is solved in Rel-17 group-based beam reporting, beams are divided into the two sets and reporting can be done for beam groups. However, the beams used by each TRP should separately follow beam refinement and pairs of beams (beam group) may be reported after such beam refinement stages per TRP. Each TRP has to transmit a large number of reference signals like SSBs and CSI-RSs, which cause overhead concerns as each beam is associated to a different SSB or CSI-RS resource.

Beam-pair prediction may help to reduce the frequency of measurements reporting, since the UE can report predicted output from measured small set of beams, therefore, it is not necessary for NW to configure UE to report full set of beam measurements to NW. During training and inference phase, the consistency between AI/ML training and inference phase needs to be ensured. For example, in UL only mode, there is a question how to ensure that UE could be in good channel condition when predicted beam-pair is corresponding to the measured two CRIs or SSBRIs from two CSI resource sets are corresponding to simultaneous UL transmission. For a UE that is configured with higher layer parameter groupBasedBeamReporting-v18 set to UL only: how the UE could select the best combination of panels that could determine simultaneous Tx corresponding to CSI-RS or SSB from each of the two CSI Resource Sets for the report setting is still open.

In accordance with some example embodiments of the present disclosure, there is provided a solution for beam prediction. The terminal device measures a low number of beams corresponding to multiple UE panels. The terminal device then determines the best simultaneous transmission beam pairs using an AI/ML model with the measurement result as input. In this way, the terminal device does not need to report a full set of beam measurements to the network device, thereby reducing overheads.

Example embodiments of the present disclosure will be described in detail below with reference to the accompanying drawings.

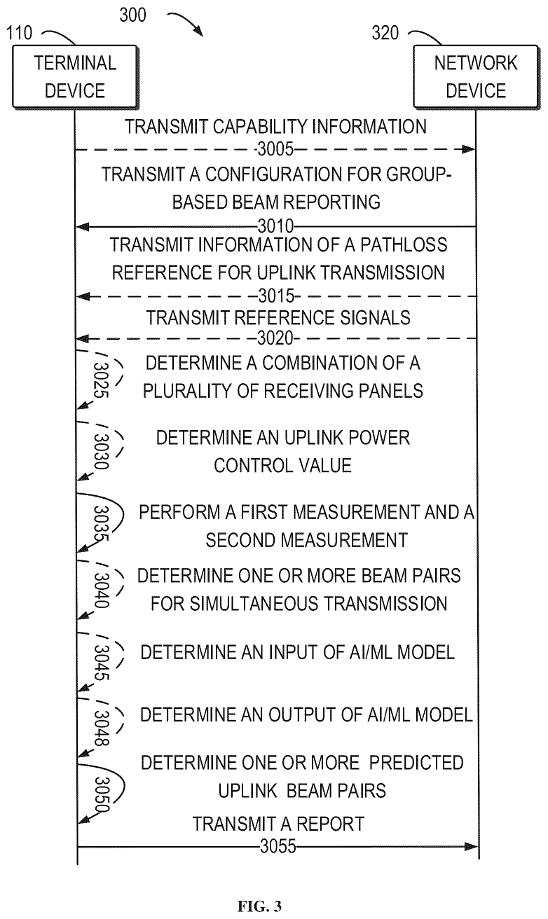

Reference is made to FIG. 3, which illustrates a signaling flow of beam prediction in accordance with some example embodiments of the present disclosure. For the purpose of discussion, the signaling flow 300 will be discussed with reference to FIG. 1, for example, by using the terminal device 110 and the network device 320. The network device 320 may be the network device 120-1 or the network device 120-2.

The terminal device 110 may transmit (3005) capability information to the network device 320. That is, the network device 320 may receive (3005) the capability information from the terminal device 110. The capability information may indicate that terminal device 110 supports group-based beam reporting with uplink only mode.

The network device 320 transmits (3010) a configuration for group-based beam reporting to the terminal device 110. That is, the terminal device 110 receives (3010) the configuration for group-based beam reporting from the network device 320. For example, the terminal device 110 may receive a CSI-report configuration to enable the group-based beam reporting based on prediction.

The configuration includes first information on a first set of beams for measurement associated with a first TRP and a second set of beams for measurement associated with a second TRP. For example, the configuration may indicate a set of beams for measurement (such as, Set B1) for the first TRP and another set of beams for measurement (such as, Set B2) for the second TRP. The configuration also includes second information regarding a third set of beams for prediction associated with the first TRP and a fourth set of beams for prediction associated with the second TRP. For example, the configuration may indicate a set of beams for prediction (such as, Set A1) for the first TRP and another set of beams for prediction (such as, Set A2) for the second TRP. In some example embodiments, the first set of beams is a subset of the third set of beams. For example, Set B1 may be a subset of Set A1. Alternatively, or in addition, the second set of beams is a subset of the fourth set of beams. For example, Set B2 may be a subset of Set A2.

In some example embodiments, in order to ensure consistency between training and inference for UE-sided model, the associated identity information for the first/second/third/fourth set of beams is introduced during training and inference phase. For example, the first information includes at least one of: codebooks of the first set of beams and the second set of beams, beam shapes of the first set of beams and the second set of beams, or qualities of the first set of beams and the second set of beams. In addition, the second information comprises at least one of: codebooks of the third set of beams and the fourth set of beams, beam shapes of the third set of beams and the fourth set of beams, or qualities of the third set of beams and the fourth set of beams. In some other example embodiments, the configuration may further include one or more of: an antenna configuration of the first TRP, an antenna configuration of the second TRP, or a pathloss reference for uplink transmission. For example, the information in the configuration which could be implicitly structured with associated IDs are as follows: SetA1/SetA2/SetB1/SetB2 codebook beams, SetA1/SetA2/SetB1/SetB2 beams shape, TRPs antenna configuration, quality of DL Tx beam pair to enable UE-sided beam prediction, the pathloss reference for UL transmission may be considered as one condition for UE to determine sounding reference signal (SRS) resources where the pathloss reference could be indicated by NW and structure within associated IDs, or other information. In some example embodiments, the beam shape may include narrow beam or wide beam. In some other example embodiments, the quality of DL Tx beam pair may include RSRP or quality of service (QOS).

In some example embodiments, the network device 320 may transmit (3015) information of a pathloss reference for uplink transmission to the terminal device 110. That is, the terminal device 110 may receive (3015) the information of the pathloss reference for uplink transmission from the network device 320. For example, the information of the pathloss reference may be sent via radio resource control (RRC) signaling. Alternatively, the information of the pathloss reference may be sent in a medium access control (MAC) control element (CE).

The network device 320 may transmit (3020) reference signals to the terminal device 110. For example, the terminal device 110 may receive (3020) measurement reference signals for Set B1 from the first TRP and measurement reference signals for Set B2 from the second TRP. In some example embodiments, the measurement reference signals may include SSB. In some other example embodiments, the measurement reference signals may include CSI reference signals.

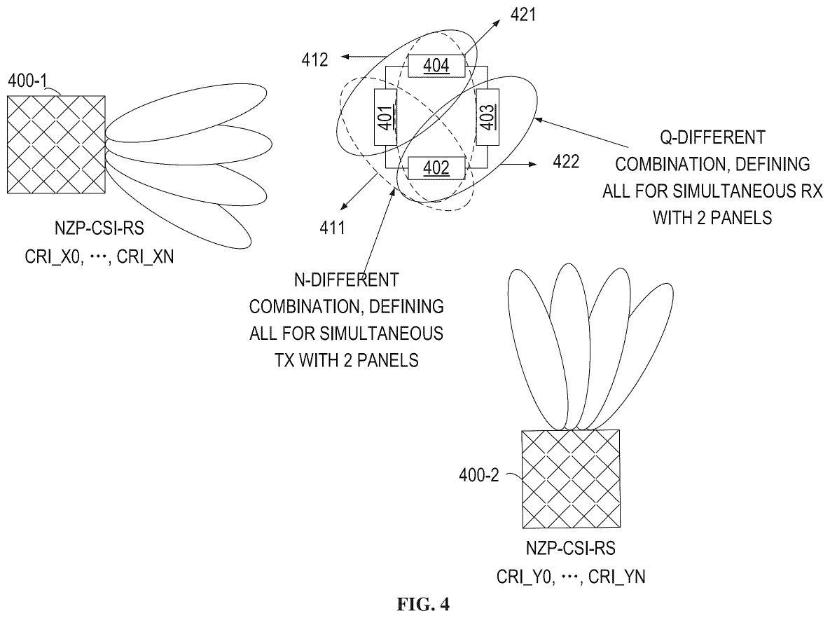

In some example embodiments, if the terminal device 110 has capability of (i) using two panels for simultaneous transmission and (ii) using two panels for simultaneous reception where each UE panel has more than one antenna, the hypothesis checking/hypothesis determination is needed for terminal device 110 to select best combinations of simultaneous transmission (Tx) corresponding to UL only. Example embodiments of determining the hypothesis are described with reference to FIG. 4 below. In some example embodiments, CSI-RS and/or SSB resources of each measurement RS resource set can be applied for simultaneous transmission with spatial filters (UL only mode).

FIG. 4 shows an example of different combinations for simultaneous transmission with two antenna panels corresponding to TRP 400-1 and TRP 400-2 and different combinations for simultaneous reception with two antenna panels corresponding to TRP 400-1 and TRP 400-2. The TRP 400-1 may be implemented at the network device 120-1 and the TRP 400-2 may be implemented at the network device 120-2. In some example embodiments, the terminal device 110 may determine N different combinations that define simultaneous transmission with 2 panels, where N is an integer and can be any suitable value. In some other example embodiments, the terminal device 110 may determine Q different combinations that define simultaneous reception with 2 panels, where Q is an integer and can be any suitable value. As shown in FIG. 4, the combination 411 of two panels 401 and 402 and the combination 421 of two panels 402 and 404 are for simultaneous transmission. The combination 412 of two panels 401 and 404 and the combination 422 of two panels 402 and 403 are for simultaneous reception.

When the terminal device 110 is configured with UL only mode, with the model training or inference for UL TX beams for simultaneous multi-panel transmission, the terminal device 110 may determine a hypothesis with the following steps.

The terminal device 110 may assume that the terminal device 110 is pre-configured with UL SRS resources with one or more UL SRS resource sets with usage ‘beam management’ associated with different TRPs. Furthermore, the terminal device 110 may assume that pre-configured UL resources are configured with UL power control values, e.g. nominal RX power at panel 401 at each TRP.

The terminal device 110 may make DL L1-RSRP measurements associated with different antenna panels from different TRPs 400-1 and 400-2 in different time instances without restriction of simultaneous reception from different TRPs with different antenna panels. In other words, the terminal device 110 performs model training/inference for UL TX beam-pair prediction with UL only mode independent of UE's simultaneous multi-panel reception capability.

The terminal device 110 may use all or select (where selection can be based on N-best L1-RSRP values associated with different antenna panels, panel specifically or over all antenna panels) measured DL L1-RSRP values (associated with SSB and/non zero power (NZP)-CSI-RS resources) of SSB/NZP-CSI-RS resources as downlink pathloss reference resources for the determination of “virtual” UL power control values for pre-configured UL SRS resources. Here, “virtual” refers to a power control value that the terminal device may use for UL SRS resources associated with different SRS resource sets when performing UL TX beam prediction for simultaneous multi-panel transmission.

Additionally, the terminal device 110 may determine (3030) a combination of a plurality of receiving panels. For example, the terminal device 110 may apply its simultaneous multi-panel transmission restriction for antenna panel selection for TX beam prediction, (e.g. there are a total of four TX antenna panels but only two out of them can be used for simultaneous transmission). By way of example, the terminal device 110 may determine the combination 411 or the combination 421. In some example embodiments, with the best combination of receiving panels, the beam sweeping procedures (such as, P1, P2 and P3) may ensure that the terminal device 110 may use best/optimal beams with respect to best panels for UL only mode.

The terminal device 110 may determine (3030) an uplink power control value that is used for uplink sounding reference signal resources. For example, when determining “virtual” power control values, the terminal device 110 may take into account hardware implementation restrictions impacting simultaneous multi-panel transmissions, such as, implemented transmitter power amplifier (PA) architecture (i.e., whether one or more power amplifiers are associated with different TX antenna panels) and TX power class of PA. In other words, how much TX power budget is available per each UL SRS resource set or across all UL SRS resource sets and resources therein, may be considered for the uplink power control value.

Referring back to FIG. 3, the terminal device 110 performs (3035) a first measurement of the first set of beams and a second measurement of the second set of beams. For example, the terminal device 110 may measure RSRPs of reference signals from the first and second sets of beams. By way of example, the terminal device 110 may measure downlink L1-RSRP measurement of at least two SSB/CSI-RS resource sets (Set B1 and Set B2).

In some example embodiments, the terminal device 110 may determine (3040) one or more beam pairs for simultaneous transmission. For example, the terminal device 110 may determine top-M beam pairs. Alternatively, or in addition, the terminal device 110 may determine beam indices of the one or more beam pairs for simultaneous transmission.

The terminal device 110 may determine (3045) an input of the AI/ML model for uplink beam pair prediction. In some example embodiments, simultaneous DL beam pairs measurement (such as, DL L1-RSRP of Set B1 and Set B2) may be determined as the input to the AI/ML model. In some example embodiments, the beam measurement with no RSRP for Set B1 corresponding to the first TRP are, for example, CRI_x1, CRI_xN, and the like, while the beam measurement with no RSRP for Set B2 corresponding to the first TRP are, for example, CRI_y4, CRI_y6, . . . CRI_yM. The two UL TX beam pairs may be identified by the terminal device 110 based on beam measurements (e.g., beam pairs, beam indices).

In some example embodiments, the input of the AI/ML model may include UL L1-RSRP based UL SRS measurements from the first TRP and the second TRP for one or more specific UL Tx antenna panels. For example, the first and second TRPs may perform UL SRS measurements and obtain UL SRS L1-RSRP values corresponding to UL SRS measurements. The first and second TRPs may then send UL SRS L1-RSRP measurements to the terminal device 110. For SRS resources, the power control coefficients used for SRS is addressed as one condition when NW triggers SRS transmission.

In some example embodiments, the input of the AI/ML model may include DL only measurements. For example,, the input of the AI/ML model may include a first downlink measurement result of the first set of beams for measurement associated with the first TRP and a second downlink measurement result of the second set of beams for measurement associated with the second TRP. By way of example, at least beam level measurements in downlink (NON-simultaneous DL beam pairs measurement), i.e., DL L1-RSRPs of SetB1 and DL L1-RSRPs of SetB2 are used at model input. Alternatively, the input of the AI/ML model may include beam pair information for the first TRP and the second TRP and corresponding measurements. For example, the input of the AI/ML model may include at least beam pair information and corresponding measurements, e.g., N best beam pairs and corresponding DL L1-RSRPs from two SSB resources or CSI-Rs resources from two resource sets (Set B1 and Set B2) for non-simultaneous reception at the terminal device 110.

In some other example embodiments, the input of the AI/ML model may include DL measurements and UL measurement. For example, the input of the AI/ML model may include the first downlink measurement result of the first set of beams for measurement associated with the first TRP and the second downlink measurement result of the second set of beams for measurement associated with the second TRP, and the first uplink measurement result associated with the first TRP and the second uplink measurement result associated with the second TRP. In some example embodiments, the input of the AI/ML model may include at least beam level measurements in downlink (non-simultaneous DL beam pairs measurement), where non-simultaneous downlink measurements include DL L1-RSRP values associated with pairs of SSB/NZP-CSI-RS resources from two different TPR, e.g., SSB/NZP-CSI-RS resources of Set B1 (corresponding to the first TRP) and SSB/NZP-CSI-RS resources of Set B1 (corresponding to the second TRP). Alternatively, the input of the AI/ML model may include at least beam level measurements in uplink, where uplink measurements consists of UL L1-RSRP values (measured by two gNBs/TRPs) associated with pairs of UL SRS resources being spatially quasi collocated (QCL)-type D configured to match with pairs of SSB and/or NZP-CSI-RS resource used as input values for model training/inference for UL TX beam prediction. Alternatively, the input of the AI/ML model may include beam pair information for the first TRP and the second TRP and corresponding measurements. For example, the input of the AI/ML model may include at least beam pair information and corresponding measurements, e.g., N best beam pairs and corresponding UL L1-RSRPs from two SSB or CSI-Rs sets (Set B1 and Set B2) for simultaneous reception at the terminal device 110.

In some further example embodiments, the input of the AI/ML model may include UL only measurements. For example, the input of the AI/ML model may include a first uplink measurement result associated with the first TRP and a second uplink measurement result associated with the second TRP. For example, the input of the AI/ML model may include at least beam level measurements in uplink, where uplink measurements include UL L1-RSRP values (measured by two gNBs/TRPs) associated with pair of UL SRS resources being spatially QCL-type D configured to match with pair of SSB and/or NZP-CSI-RS resource used. In some example embodiments, the input of the AI/ML model may include beam pair information for the first TRP and the second TRP and corresponding measurements. For example, the input of the AI/ML model may include at least beam pair information and corresponding measurements, e.g., N best beam pairs and corresponding UL L1-RSRPs from two SSB or CSI-Rs sets (Set B1 and Set B2) for non-simultaneous reception at the terminal device 110.

In addition, the input of the AI/ML model may include additional information. For example, the additional information may include one or more receiving panel ID(s). The additional information may also include a position of the terminal device 110.

The terminal device 110 may determine (3048) an output of the AI/ML model by applying the input of the AI/ML model. In some example embodiments, the output of the AI/ML model may include identity information of one or more predicted beam pairs. Alternatively, or in addition, the output of the AI/ML model may include RSRP of one or more predicted beam pairs. In some further example embodiments, the output of the AI/ML model further includes probability values of the one or more predicted beam pairs.

In some example embodiments, the AI/ML model may be a convolutional neural network (CNN) model. For example, the first layer of neural network (NN) may take input (such as, beam measurements) including: UL L1-RSRP values (measured by two gNBs(such as, the network devices 120-1 and 120-2)/TRPs) associated with pairs of UL SRS with pairs of SSB and/or NZP-CSI-RS resource; and CRI and RSRP measurements for each set of beams (Set B1 and Set B2) on CSI-RS resources and identified best beam pairs, e.g., (xi, yj) (i, j are selected from within (i=1, . . . , N), where N is number of beams in Set B1 and Set B2), assuming that Set B1 and Set B2 have equal number of beams (N beams). The next layer of the CNN model may be convolutional layer, which will extract the feature from input dataset. Then activation layer may add activation function to preceding later, where the activation functions could be rectified linear unit (RELU), hyperbolic tangent (Tanh) and the like. The CNN model may include pooling and flattening layer, where the pooling layer could be used to reduce the size of volume and flattening layer is used to map into one-dimensional vector, respectively. The next layer may be fully-connected layer and the last layer may be Softmax function to obtain the probability distribution over the set of model output. Then, these probabilities may be ranked for instance. Alternatively, the AI/ML model may be a deep reinforcement learning model.

Alternatively, the AI/ML model may be a feed-forward neural network. The first layer of neural network (NN) may take input (such as, beam measurements) including CRI and RSRP measurements for each set of beams (Set B1 and Set B2) on CSI-RS resources and identified best beam pairs, e.g., (xi, yj) (i, j are selected from within (i=1, . . . , N), where N is number of beams in Set B1 and Set B2), assuming that Set B1 and Set B2 have equal number of beams (N beams). The next layer is a neural network (NN) block, where each NN Block has multiple neurons. Each NN block may include fully connected layers and then the last layer may be Softmax function to obtain the probability distribution over the set of model output. Then, these probabilities may be ranked for instance.

As another example, the AI/ML model may be a long short-term memory (LSTM) model. The LSTM architecture may have three parts which are forget gate, input gate and output Gate. In the first layer, the forget gate may take input (such as, beam measurements) including UL L1-RSRP values (measured by two gNBs/TRPs) associated with pairs of UL SRS with pairs of SSB and/or ZP-CSI-RS resource; and CRI and RSRP measurements for each set of beams (Set B1 and Set B2) on CSI-RS resources and identified best beam pairs, e.g., (xi, yj) (i, j are selected from within (i=1, . . . , N), where N is number of beams in Set B1 and Set B2), assuming that Set B1 and Set B2 have equal number of beams (N beams). The input at time instance t may be denoted as xₜ. In the forget gate, it has a hidden state where H(t−1) represents the hidden state of the previous time instance, the equation of forget gate is fₜ=σ(W_{f}*[Hₜ₋₁, Xₜ]+b_{f}), where W_{f} represents a weight matrix associated with the forget gate, [Hₜ₋₁, Xₜ] denotes a concatenation of the input and the hidden state of the previous time instance, bf is the bias with forget gate, and σ is the sigmoid activation function. In input gate, it may include sigmoid function σ(.) and activation function, tanh(.), as follow: iₜ=σ(Wᵢ*[Hₜ₋₁, x+]+bᵢ) and Ĉₜ=tanh(W_{c}*[Hₜ₋₁,xₜ]+b_{c}), where Wᵢ, W_{c}, bᵢ, b_{c} are weight matrices and bias vectors for the input gate, respectively. The previous state may then multiplied by forget gate at time t (fₜ), then iₜ⊙Ĉₜ is included where ⊙ denotes element-wise multiplication as follow Cₜ=fₜ⊙Cₜ₋₁+iₜ⊙Ĉₜ. In output gate, oₜ=σ(Wₒ*[Hₜ₋₁,xₜ]+bₒ), where Wₒ and bₒ are weight matrix and bias vector for output gate. Then last function can be Softmax function to obtain the probability distribution over the set of model output. Then, these probabilities may be ranked for instance.

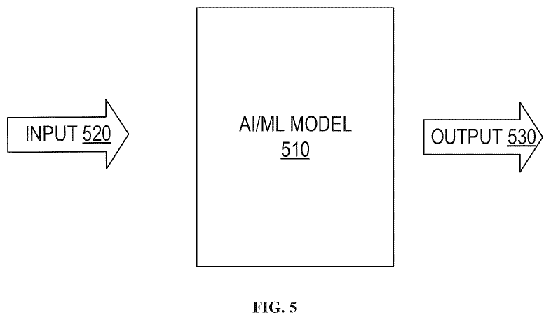

FIG. 5 illustrates a schematic diagram of AI/ML model for spatial domain beam pair prediction according to some example embodiments of the present disclosure. For example, the output 530 of the AI/ML model 510 is obtained by applying the input 520 to the AI/ML model 510. In some example embodiments, the AI/ML model 510 may be implemented with a CNN or feed forward neural network. Alternatively, the AI/ML model 510 may be implemented with a LSTM model. In some other example embodiments, the AI/ML model may be a deep reinforcement learning model.

In some example embodiments, the input 520 may include beam measurements for Set B1 that include L1-RSRP_beam_x1 (and/or CRI_beam_x1), . . . , L1-RSRP_beam_xN (and/or CRI_beam_xN) and beam measurements for Set B2 that include L1-RSRP_beam_y1(and/or CRI_beam_x1), . . . , L1-RSRP_beam_yN (and/or CRI_beam_yN). Alternatively, or in addition, the input 520 may include Top-N best UL Tx beam-pairs for simultaneous beam-pairs measurements (Set B1 to Set A1) and (Set B2 to Set A2) that includes, for example, L1-RSRP of UL Tx beam-pair (xi, yj) (and/or CRI of UL Tx beam-pair (xi, yj)), . . . , L1-RSRP of UL beam-pair (x1, yN) (and/or CRI of Tx UL beam-pair (x1, yN). In some other example embodiments, the input 520 may include UL SRS measurements from the first TRP (Set B1) that include UL L1-RSRP_beam_x1 (and/or CRI_beam_x1), . . . , UL L1-RSRP beam_xN (and/or CRI_beam_xN) and UL SRS measurements from the second TRP (Set B2) that include UL L1-RSRP_beam_y1 (and/or CRI_beam_y1), . . . , UL L1-RSRP_beam_yN (and/or CRI_beam_yN). The input 520 may include UE Panel ID(s), such as, Panel ID_M1, . . . , Panel ID_MN. It is noted that inputs 520 may include any combinations of the above-mentioned inputs.

The output 530 of the AI/ML model 510 may include predicted best UL Top-K Tx beam pairs IDs from two CSI-RS sets (Set A1 and Set A2), e.g., {predicted CRI_x1 (PCRI_x1), predicted CRI_y2 (PCR_y2)}, . . . , {predicted CRI_xN (PCR_xN), predicted CRI_yN+1(PCRI_yN+1)}. The default value of K may be 1. Alternatively, the output 530 of the AI/ML model 510 may include predicted UL RSRP of best Tx Top-K beam pairs (beam pairs IDs) from Set A1 and Set A2, e.g., {predicted RSRP_x1 (PRSRP_x1), predicted RSRP_y2 (PRSRP_y2)}, . . . , {predicted RSRP_xN (PRSRP_xN), predicted RSRP_yN+1 (PRSRP_yN+1)}. In addition, the output 530 of the AI/ML model 510 may include probability values of best Tx Top-K beam pairs (beam pairs IDs) from Set A1 and Set A2.

In some example embodiments, the input of the AI/ML model and the output of the AI/ML model are in a same spatial domain. For example, for temporal domain UL Tx beam-pair prediction, the input and output may be the same as in spatial domain, but the input may be historical of measurements and predicted output may be in multiple future time instances. The input of the AI/ML model may be historical data of measurements. For example, for UL SRS measurements, the historical data of measurements may include the historical L1-RSRP based UL SRS measurements of Set B1 from the first TRP (e.g., {UL SRS L1-RSRP_beam_x1 (and/or CRI_beam_x1), . . . , UL SRS L1-RSRP beam xN (and/or CRI_beam_xN)} from time t-M. t-M-1, . . . t)) and the historical L1-RSRP based UL SRS measurements of Set B2 from the second TRP (e.g., {UL SRS LI-RSRP_beam_y1 (and/or CRI_beam_y1), . . . , UL SRS LI-RSRP_beam_yM (and/or CRI_beam_yM)} from time t-M. t-M-1, . . . t)).

In some other example embodiments, for other input parameter, they are the same as for spatial domain UL Tx beam-pair prediction, but the input could be in historical measurements (e.g., from time t-M, t-M-1, . . . , t). The model for temporal UL Tx-beam pair prediction can be, e.g., transformer model. LSTM, auto encoder-decoder, and etc.

The terminal device 110 determines (3050), based on measurement results of the first and second measurements, one or more predicted uplink beam pairs using the AI/ML model. Each predicted uplink beam pair includes a first beam from the third set of beams and a second beam from the fourth set of beams. In some example embodiments, the predicted uplink beam pair could comprise at least one first beam from the third set of beams and at least one second beam from fourth set of beams. For example, the predicted uplink beam-pair may be, for example, predicted Top-2 uplink beam-pair of the first TRP and predicted Top-2 uplink beam-pair of the second TRP.

The terminal device 110 transmits (3055) a report associated with the one or more predicted uplink beam pairs to the network device 120. That is, the network device 120 may receive (3055) the report associated with the one or more predicted uplink beam pairs. In some example embodiments, the report may include identity information of the one or more predicted beam pairs. Alternatively, or in addition, the report may include reference signal received power of the one or more predicted beam pairs.

In some example embodiments, based on the measured DL L1-RSRP and the uplink power values associated with pre-configured UL SRS resources, the terminal device 110 predicts UL TX beams for simultaneous multi-panel transmissions and reports corresponding DL SSB and/or NZP-CSI-RS resources and downlink L1-RSRP values associated with different TRPs. Alternatively, based on the measured DL L1-RSRP of SSB and/or NZP-CSI-RS resources and indicated/configured UL L1-RSRP of UL SRS measurements at different TPRs and the uplink power values associated with pre-configured UL SRS resources, the terminal device 110 predicts UL TX beams for simultaneous multi-panel transmissions and reports corresponding DL SSB and/or NZP-CSI-RS resources and downlink L1-RSRP values associated with different TRPs.

Reference is made to FIG. 6, which illustrates a signaling flow of beam prediction in accordance with some example embodiments of the present disclosure. For the purpose of discussion, the signaling flow 600 will be discussed with reference to FIG. 1, for example, by using the terminal device 110 and TRPs 620-1 and 620-2. The TRP 620-1 may be implemented at the network device 120-1 and the TRP 620-2 may be implemented at the network device 120-2. The terminal device 110 may include a prediction model 711, a measurement entity 712, an UL entity 713 and a DL entity 714.

The terminal device 110 may send (6005) capability indication to NW (group-based beam reporting with UL only), such as, to the TRP 620-1. The TRP 620-1 may configure (6010) a CSI-ReportConfig with group-based beam reporting and indicate RS sets (Set B1/B2) and (SetA1/A2) for AI/ML UL Tx beam-pair prediction (with structure associated IDs in NZP-CSI-RS-ResourceSet for measurements and in NZP-CSI-RS-ResourceSet for prediction) to the terminal device 110. Optionally, if the pathloss reference is not in associated ID, the TRP 620-1 may send (6015) pathloss reference in RRC/MAC-CE.

The terminal device 110 may determine (6020) the use of prediction model for CSI-ReporConfig. The TRP 620-1 may transmit (6025) measurement RSs using Set B1 and the TRP 620-2 may transmit (6030) measurement RSs using Set B2.

The terminal device 110 may determine (6035) a hypothesis for simultaneous transmission (UL only). The terminal device 110 may also select best two panels combination for simultaneous transmission (UL only).

The terminal device 110 may perform (6040) beam measurements of RS SetB1 and SetB2. The terminal device 110 may determine beam pairs for simultaneous transmission (UL only).

The terminal device 110 may determine (6045) input of beam measurements (e.g., Top-M beam pairs and/or beam indices +DL L1-RSRP+UL SRS L1-RSRP). The terminal device 110 may perform (6050) UL group-based beam prediction (using, e.g., Top-M beam pairs and/or beam indices and DL L1-RSRP and UL SRS L1-RSRP). The terminal device 110 may report (6055 and 6060) predicted UL Top-K beam pairs IDs (and/or predicted UL Top-K beam pairs L1-RSRP) to the TRP 620-1 and/or TRP 620-2. The predicted UL Top-K beam pairs IDs (and/or predicted UL Top-K beam pairs L1-RSRP) may be included in a CSI report.

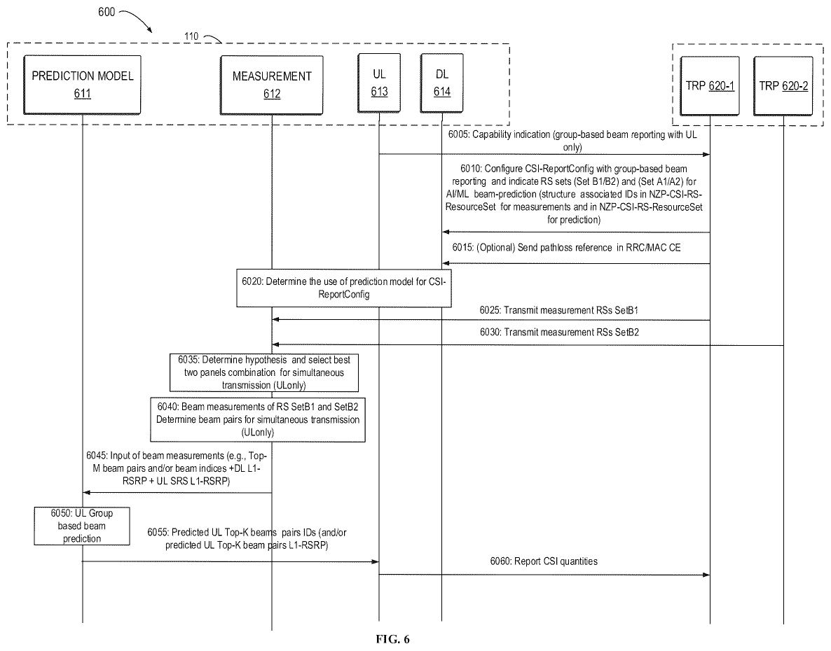

FIG. 7 shows a flowchart of an example method 700 implemented at a first apparatus in accordance with some example embodiments of the present disclosure. For example, the method 700 may be implemented at the terminal device 110 in FIG. 1.

At block 710, the first apparatus receives, from a second apparatus, a configuration for group-based beam reporting. The configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP.

At block 720, the first apparatus performs a first measurement of the first set of beams and a second measurement of the second set of beams.

At block 730, the first apparatus determines, based on measurement results of the first and second measurements, one or more predicted uplink beam pairs using an artificial intelligence/machine learning, AI/ML model. Each predicted uplink beam pair comprising a first beam from the third set of beams and a second beam from the fourth set of beams.

At block 740, the first apparatus transmits, to the second apparatus, a report associated with the one or more predicted uplink beam pairs.

In some example embodiments, the report comprises at least one of: identity information of the one or more predicted beam pairs, or reference signal received power of the one or more predicted beam pairs.

In some example embodiments, the first information comprises at least one of: codebooks of the first set of beams and the second set of beams, beam shapes of the first set of beams and the second set of beams, or qualities of the first set of beams and the second set of beams, and wherein the second information comprises at least one of: codebooks of the third set of beams and the fourth set of beams, beam shapes of the third set of beams and the fourth set of beams, or qualities of the third set of beams and the fourth set of beams.

In some example embodiments, the configuration further includes at least one associated identity which comprises at least one of: an antenna configuration of the first TRP, an antenna configuration of the second TRP, or a pathloss reference for uplink transmission.

In some example embodiments, an input of the AI/ML model comprises at least one of: the measurement results of the first and second measurements, an identity of receiving panel of the first apparatus, a position of the first apparatus, an uplink sounding reference signal measurement from the first TRP for a transmitting panel, an uplink sounding reference signal measurement from the second TRP for the transmitting panel, or an uplink power control value.

In some example embodiments, the method 700 further comprises: receiving, from the second apparatus, information of the pathloss reference for uplink transmission.

In some example embodiments, the information of the pathloss reference for uplink transmission is received from a radio resource control configuration or a medium access control control element.

In some example embodiments, the method 700 further comprises: determining an uplink power control value that is used for uplink sounding reference signal resources.

In some example embodiments, the method 700 further comprises: determining a combination of a plurality of receiving panels for simultaneous transmission.

In some example embodiments, the method 700 further comprises: determining one or more beam pairs for simultaneous transmission.

In some example embodiments, the first set of beams is a subset of the third set of beams, and the second set of beams is a subset of the fourth set of beams.

In some example embodiments, the first apparatus is a terminal device, and the second apparatus is a network device.

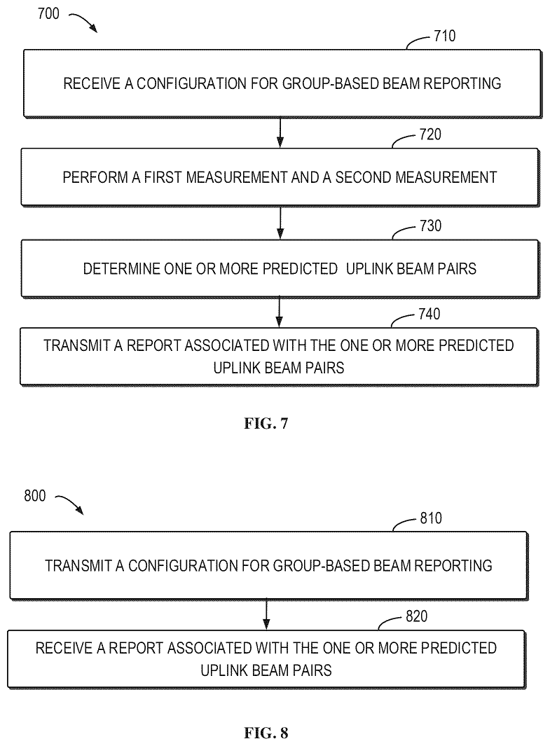

FIG. 8 shows a flowchart of an example method 800 implemented at a second apparatus in accordance with some example embodiments of the present disclosure. For example, the method 800 may be implemented at the network device 120 (such as, the network device 120-1 and/or network device 120-2) in FIG. 1.

At block 810, the second apparatus transmits, to a first apparatus, a configuration for group-based beam reporting. The configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP.

At block 820, the second apparatus receives, from the first apparatus, a report associated with one or more predicted uplink beam pairs. The one or more predicted uplink beam pairs are determined using an artificial intelligence/machine learning, AI/ML model, each predicted uplink beam pair comprising a first beam from the third set of beams and a second beam from the fourth set of beams.

In some example embodiments, the report comprises at least one of: identity information of the one or more predicted beam pairs, or reference signal received power of the one or more predicted beam pairs.

In some example embodiments, the first information comprises at least one of: codebooks of the first set of beams and the second set of beams, beam shapes of the first set of beams and the second set of beams, or qualities of the first set of beams and the second set of beams, and wherein the second information comprises at least one of: codebooks of the third set of beams and the fourth set of beams, beam shapes of the third set of beams and the fourth set of beams, or qualities of the third set of beams and the fourth set of beams.

In some example embodiments, the configuration further includes at least one associated identity which comprises at least one of: an antenna configuration of the first TRP, an antenna configuration of the second TRP, or a pathloss reference for uplink transmission.

In some example embodiments, the method 800 further comprises: transmitting, to the first apparatus, information of the pathloss reference for uplink transmission.

In some example embodiments, the information of the pathloss reference for uplink transmission is transmitted in a radio resource control configuration or a medium access control control element.

In some example embodiments, the first set of beams is a subset of the third set of beams, and the second set of beams is a subset of the fourth set of beams.

In some example embodiments, the first apparatus is a terminal device, and the second apparatus is a network device.

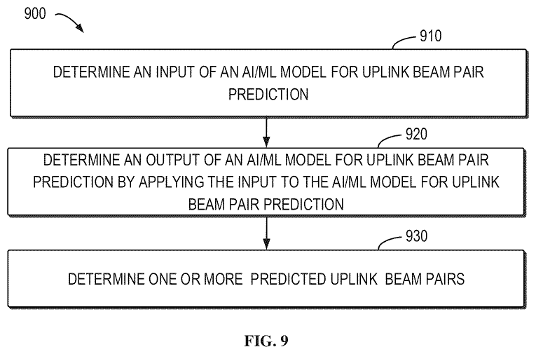

FIG. 9 shows a flowchart of an example method 900 implemented at an apparatus in accordance with some example embodiments of the present disclosure. For example, the method 900 may be implemented at the terminal device 110 and/or the network device 120 (such as, the network device 120-1 and/or network device 120-2) in FIG. 1.

At block 910, the apparatus determines an input of an artificial intelligence/machine learning, AI/ML model for uplink beam pair prediction.

At block 920, the apparatus determines an output of the AI/ML model for uplink beam pair prediction by applying the input to the AI/ML model for uplink beam pair prediction.

At block 930, the apparatus determines, based on the output of the AI/ML model for uplink beam pair prediction, one or more predicted uplink beam pairs, each predicted uplink beam pair comprising a first beam for a first transmission reception point, TRP, and a second beam for a second TRP.

In some example embodiments, the input of the AI/ML model comprises at least one of: a first downlink measurement result of a first set of beams for measurement associated with the first TRP and a second downlink measurement result of a second set of beams for measurement associated with the second TRP, a first uplink measurement result associated with the first TRP and a second uplink measurement result associated with the second TRP, or beam pair information for the first TRP and the second TRP and corresponding measurements.

In some example embodiments, the input of the AI/ML model further comprises at least one of: an identity of a receiving panel of a terminal device, a position of the terminal device, or an uplink power control value.

In some example embodiments, the output of the AI/ML model comprises at least one of: identity information of the one or more predicted beam pairs, or reference signal received power of the one or more predicted beam pairs.

In some example embodiments, the output of the AI/ML model further comprises probability values of the one or more predicted beam pairs.

In some example embodiments, the input of the AI/ML model and the output of the AI/ML model are in a same spatial domain.

In some example embodiments, the input of the AI/ML model is historical data of measurements.

In some example embodiments, the method 900 further comprises: determining an uplink power control value that is used for uplink sounding reference signal resources.

In some example embodiments, the apparatus is pre-configured with uplink sounding reference signal resources with one or more uplink sounding reference signal resource sets used for beam management associated with different transmission reception points.

In some example embodiments, the pre-configured uplink sounding reference signal resources are configured with uplink power control value.

In some example embodiments, the method 900 further comprises: applying a simultaneous multi-panel transmission restriction for antenna panel selection for uplink beam pair prediction.

In some example embodiments, the apparatus is a terminal device or a network device.

In some example embodiments, the apparatus is a terminal device which is a user equipment.

It is noted the example embodiments described with reference to FIG. 3 to FIG. 9 can be implemented separately or in any suitable combinations. For example, example embodiments described with reference to one drawing can be combined. Alternatively, or in addition, example embodiments described with reference to different drawings can be combined.

In some example embodiments, a first apparatus capable of performing any of the method 700 (for example, the terminal device 110 in FIG. 1) may comprise means for performing the respective operations of the method 700. The means may be implemented in any suitable form. For example, the means may be implemented in a circuitry or software module. The first apparatus may be implemented as or included in the terminal device 110 in FIG. 1.

In some example embodiments, the first apparatus comprises means for receiving, from a second apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP, and the configuration further comprises at least one associated identity which comprises at least one of: an antenna configuration of the first TRP, an antenna configuration of the second TRP, or a pathloss reference for uplink transmission; means for performing a first measurement of the first set of beams and a second measurement of the second set of beams; means for determining, based on measurement results of the first and second measurements, one or more predicted uplink beam pairs using an artificial intelligence/machine learning, AI/ML model, each predicted uplink beam pair comprising a first beam from the third set of beams and a second beam from the fourth set of beams; and means for transmitting, to the second apparatus, a report associated with the one or more predicted uplink beam pairs.

In some example embodiments, the report comprises at least one of: identify information of the one or more predicted beam pairs, or reference signal received power of the one or more predicted beam pairs.

In some example embodiments, the first information comprises at least one of: codebooks of the first set of beams and the second set of beams, beam shapes of the first set of beams and the second set of beams, or qualities of the first set of beams and the second set of beams, and wherein the second information comprises at least one of: codebooks of the third set of beams and the fourth set of beams, beam shapes of the third set of beams and the fourth set of beams, or qualities of the third set of beams and the fourth set of beams.

In some example embodiments, an input of the AI/ML model comprises at least one of: the measurement results of the first and second measurements, an identity of receiving panel of the first apparatus, a position of the first apparatus, an uplink sounding reference signal measurement from the first TRP for a transmitting panel, an uplink sounding reference signal measurement from the second TRP for the transmitting panel, or an uplink power control value.

In some example embodiments, the first apparatus further comprises: means for receiving, from the second apparatus, information of the pathloss reference for uplink transmission.

In some example embodiments, the first apparatus further comprises: means for determining an uplink power control value that is used for uplink sounding reference signal resources.

In some example embodiments, the first apparatus further comprises: means for determining a combination of a plurality of receiving panels for simultaneous transmission.

In some example embodiments, the first apparatus further comprises: means for determining one or more beam pairs for simultaneous transmission.

In some example embodiments, the first set of beams is a subset of the third set of beams, and the second set of beams is a subset of the fourth set of beams.

In some example embodiments, the first apparatus is a terminal device, and the second apparatus is a network device.

In some example embodiments, a second apparatus capable of performing any of the method 800 (for example, the network device 120 in FIG. 1) may comprise means for performing the respective operations of the method 800. The means may be implemented in any suitable form. For example, the means may be implemented in a circuitry or software module. The second apparatus may be implemented as or included in the network device 120 in FIG. 1.

In some example embodiments, the second apparatus comprises means for transmitting, to a first apparatus, a configuration for group-based beam reporting, wherein the configuration comprises first information on a first set of beams for measurement associated with a first transmission reception point, TRP, and a second set of beams for measurement associated with a second TRP, and second information regarding a third set of beams for prediction associated with the first TRP and a fourth set of beams for prediction associated with the second TRP, and the configuration further comprises at least one associated identity which comprises at least one of: an antenna configuration of the first TRP, an antenna configuration of the second TRP, or a pathloss reference for uplink transmission; and means for receiving, from the first apparatus, a report associated with one or more predicted uplink beam pairs, wherein the one or more predicted uplink beam pairs are determined using an artificial intelligence/machine learning, AI/ML model, each predicted uplink beam pair comprising a first beam from the third set of beams and a second beam from the fourth set of beams.

In some example embodiments, the report comprises at least one of: identity information of the one or more predicted beam pairs, or reference signal received power of the one or more predicted beam pairs.

In some example embodiments, the first information comprises at least one of: codebooks of the first set of beams and the second set of beams, beam shapes of the first set of beams and the second set of beams, or qualities of the first set of beams and the second set of beams, and wherein the second information comprises at least one of: codebooks of the third set of beams and the fourth set of beams, beam shapes of the third set of beams and the fourth set of beams, or qualities of the third set of beams and the fourth set of beams.

In some example embodiments, the second apparatus further comprises: means for transmitting, to the first apparatus, information of a pathloss reference for uplink transmission.

In some example embodiments, the first set of beams is a subset of the third set of beams, and the second set of beams is a subset of the fourth set of beams.

In some example embodiments, the first apparatus is a terminal device, and the second apparatus is a network device.

In some example embodiments, an apparatus capable of performing any of the method 900 (for example, the terminal device 110 and/or the network device 120 in FIG. 1) may comprise means for performing the respective operations of the method 900. The means may be implemented in any suitable form. For example, the means may be implemented in a circuitry or software module. The apparatus may be implemented as or included in the terminal device 110 and/or the network device 120 in FIG. 1.

In some example embodiments, the apparatus comprises means for determining an input of an artificial intelligence/machine learning, AI/ML model for uplink beam pair prediction; means for determining an output of the AI/ML model for uplink beam pair prediction by applying the input to the AI/ML model for uplink beam pair prediction; and means for determining, based on the output of the AI/ML model for uplink beam pair prediction, one or more predicted uplink beam pairs, each predicted uplink beam pair comprising a first beam for a first transmission reception point, TRP, and a second beam for a second TRP.

In some example embodiments, the input of the AI/ML model comprises at least one of: a first downlink measurement result of a first set of beams for measurement associated with the first TRP and a second downlink measurement result of a second set of beams for measurement associated with the second TRP, a first uplink measurement result associated with the first TRP and a second uplink measurement result associated with the second TRP, or beam pair information for the first TRP and the second TRP and corresponding measurements.

In some example embodiments, the input of the AI/ML model further comprises at least one of: an identity of a receiving panel of a terminal device, a position of the terminal device, or an uplink power control value.

In some example embodiments, the output of the AI/ML model comprises at least one of: identity information of the one or more predicted beam pairs, or reference signal received power of the one or more predicted beam pairs.

In some example embodiments, the output of the AI/ML model further comprises probability values of the one or more predicted beam pairs.

In some example embodiments, the input of the AI/ML model and the output of the AI/ML model are in a same spatial domain.

In some example embodiments, the input of the AI/ML model is historical data of measurements.

In some example embodiments, the apparatus further comprises means for determining an uplink power control value that is used for uplink sounding reference signal resources.

In some example embodiments, the apparatus is pre-configured with uplink sounding reference signal resources with one or more uplink sounding reference signal resource sets used for beam management associated with different transmission reception points.

In some example embodiments, the pre-configured uplink sounding reference signal resources are configured with uplink power control value.

In some example embodiments, the apparatus further comprises means for applying a simultaneous multi-panel transmission restriction for antenna panel selection for uplink beam pair prediction.

In some example embodiments, the apparatus is a terminal device or a network device.

In some example embodiments, the apparatus is a terminal device which is a user equipment.

Some/further embodiments of the present disclosure include the following examples.

Example 1. An apparatus comprising: at least one processor; and at least one memory storing instructions that, when executed by the at least one processor, cause the apparatus to: determine an input of an artificial intelligence/machine learning, AI/ML model for uplink beam pair prediction; determine an output of the AI/ML model for uplink beam pair prediction by applying the input to the AI/ML model for uplink beam pair prediction; and determine, based on the output of the AI/ML model for uplink beam pair prediction, one or more predicted uplink beam pairs, each predicted uplink beam pair comprising a first beam for a first transmission reception point, TRP, and a second beam for a second TRP.

Example 2. The apparatus of example 1, wherein the input of the AI/ML model comprises at least one of: a first downlink measurement result of a first set of beams for measurement associated with the first TRP and a second downlink measurement result of a second set of beams for measurement associated with the second TRP, a first uplink measurement result associated with the first TRP and a second uplink measurement result associated with the second TRP, or beam pair information for the first TRP and the second TRP and corresponding measurements.

Example 3. The apparatus of example 1 or example 2, wherein the input of the AI/ML model further comprises at least one of: an identity of a receiving panel of a terminal device, a position of the terminal device, or an uplink power control value.

Example 4. The apparatus of any of examples 1 to 3, wherein the output of the AI/ML model comprises at least one of: identity information of the one or more predicted beam pairs, or reference signal received power of the one or more predicted beam pairs.

Example 5. The apparatus of any of examples 1 to 4, wherein the output of the AI/ML model further comprises probability values of the one or more predicted beam pairs.

Example 6. The apparatus of any of examples 1 to 5, wherein the input of the AI/ML model and the output of the AI/ML model are in a same spatial domain.

Example 7. The apparatus of any of examples 1 to 6, wherein the input of the AI/ML model is historical data of measurements.

Example 8. The apparatus of any of examples 1 to 7, wherein the apparatus is caused to: determine an uplink power control value that is used for uplink sounding reference signal resources.

Example 9. The apparatus of any of examples 1 to 8, wherein the apparatus is pre-configured with uplink sounding reference signal resources with one or more uplink sounding reference signal resource sets used for beam management associated with different transmission reception points.

Example 10. The apparatus of example 9, wherein the pre-configured uplink sounding reference signal resources are configured with uplink power control value.

Example 11. The apparatus of any of examples 1 to 9, wherein the apparatus is caused to: apply a simultaneous multi-panel transmission restriction for antenna panel selection for uplink beam pair prediction.

Example 12. The apparatus of any of examples 1 to 11, wherein the apparatus is a terminal device or a network device.

Example 13. The apparatus of example 12, wherein the apparatus is a terminal device which is a user equipment.

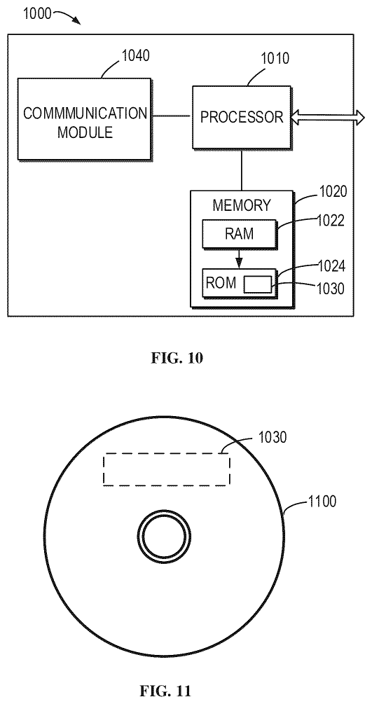

FIG. 10 is a simplified block diagram of a device 1000 that is suitable for implementing example embodiments of the present disclosure. The device 1000 may be provided to implement a communication device, for example, the terminal device 110 or the network device 120 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus to:
determine an input of an artificial intelligence/machine learning, AI/ML model for uplink beam pair prediction;
determine an output of the AI/ML model for uplink beam pair prediction by applying the input to the AI/ML model for uplink beam pair prediction; and
determine, based on the output of the AI/ML model for uplink beam pair prediction, one or more predicted uplink beam pairs, each predicted uplink beam pair comprising a first beam for a first transmission reception point, TRP, and a second beam for a second TRP.

2. The apparatus of claim 1, wherein the input of the AI/ML model comprises at least one of:
a first downlink measurement result of a first set of beams for measurement associated with the first TRP and a second downlink measurement result of a second set of beams for measurement associated with the second TRP,
a first uplink measurement result associated with the first TRP and a second uplink measurement result associated with the second TRP, or
beam pair information for the first TRP and the second TRP and corresponding measurements.

3. The apparatus of claim 1, wherein the input of the AI/ML model further comprises at least one of:
an identity of a receiving panel of a terminal device,
a position of the terminal device, or
an uplink power control value.

4. The apparatus of claim 1, wherein the output of the AI/ML model comprises at least one of:
identity information of the one or more predicted beam pairs, or
reference signal received power of the one or more predicted beam pairs.

5. The apparatus of claim 1, wherein the output of the AI/ML model further comprises probability values of the one or more predicted beam pairs.

6. The apparatus of claim 1, wherein the input of the AI/ML model and the output of the AI/ML model are in a same spatial domain.

7. The apparatus of claim 1, wherein the input of the AI/ML model is historical data of measurements.

8. The apparatus of claim 1, wherein the apparatus is caused to:
determine an uplink power control value that is used for uplink sounding reference signal resources.

9. The apparatus of claim 1, wherein the apparatus is pre-configured with uplink sounding reference signal resources with one or more uplink sounding reference signal resource sets used for beam management associated with different transmission reception points.

10. The apparatus of claim 9, wherein the pre-configured uplink sounding reference signal resources are configured with uplink power control value.

11. The apparatus of claim 1, wherein the apparatus is caused to:
apply a simultaneous multi-panel transmission restriction for antenna panel selection for uplink beam pair prediction.

12. The apparatus of claim 1, wherein the apparatus is a terminal device or a network device.

13. The apparatus of claim 12, wherein the apparatus is a terminal device which is a user equipment.

14. A method comprising:
determining, at an apparatus, an input of an artificial intelligence/machine learning, AI/ML model for uplink beam pair prediction;
determining an output of the AI/ML model for uplink beam pair prediction by applying the input to the AI/ML model for uplink beam pair prediction; and
determining, based on the output of the AI/ML model for uplink beam pair prediction, one or more predicted uplink beam pairs, each predicted uplink beam pair comprising a first beam for a first transmission reception point, TRP, and a second beam for a second TRP.

15. A non-transitory computer readable medium comprising instructions stored thereon for causing an apparatus at least to perform the method of claim 14.

16. The method of claim 14, wherein the input of the AI/ML model comprises at least one of:
a first downlink measurement result of a first set of beams for measurement associated with the first TRP and a second downlink measurement result of a second set of beams for measurement associated with the second TRP,
a first uplink measurement result associated with the first TRP and a second uplink measurement result associated with the second TRP, or
beam pair information for the first TRP and the second TRP and corresponding measurements.

17. The method of claim 14, wherein the input of the AI/ML model further comprises at least one of:
an identity of a receiving panel of a terminal device,
a position of the terminal device, or
an uplink power control value.

18. The method of claim 14, wherein the output of the AI/ML model comprises at least one of:
identity information of the one or more predicted beam pairs, or
reference signal received power of the one or more predicted beam pairs.

19. The method of claim 14, further comprising:
determining an uplink power control value that is used for uplink sounding reference signal resources.

20. The method of claim 14, further comprising:
applying a simultaneous multi-panel transmission restriction for antenna panel selection for uplink beam pair prediction.
